(19) United States
(12) Patent Application Publication
(10) Pub. No.: US 2005/0123139 A1
(43) Pub. Date: Jun. 9, 2005

(54) METHOD FOR MANAGING A BUFFER MEMORY IN A CRYPTO ENGINE

(76) Inventor: Wen-Long Chin, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,381

(22) Filed: Dec. 9, 2003

(51) Int. Cl. H04L 9/00

(52) U.S. Cl. 380/265

(57) ABSTRACT

A method for managing a buffer memory in a crypto engine includes defining an IO writing address, a program reading address, a program writing address, and an IO reading address in the buffer memory. Input data is written into the IO writing address, and then the crypto engine reads the input data beginning at the program reading address to perform encryption or decryption processes. After the encryption or decryption processes, result of the processes is written into the program writing address, and then the result is read beginning at the IO reading address. When the IO writing address is different from the program reading address, the crypto engine is controlled to read the input data. When the program writing address is different from the IO reading address, the buffer memory is controlled to output the result.

### BACKGROUND OF INVENTION

1. Field of the Invention

The invention relates to a method for managing a buffer memory in a crypto engine, and more particularly, to a method for managing a buffer memory with multiple functions, wherein the buffer memory is divided into two areas to manage.

2. Description of the Prior Art

The trend of an increasing electronic society places an increasing importance on the safety of data transmission. All the security of the Internet, electronic commerce or telecommunication involve cryptography technology. The encryption algorithm is one of the important technologies of data security, and the data encryption standard (DES) published by the U.S. government in 1977 is generally used. Other familiar encryption algorithms include the triple-DES and the advanced encryption standard (AES).

Please refer to FIG. 1, which is a functional diagram of a conventional encryption/decryption procedure. When a plain text 14 is transmitted from a sender 11 to a receiver 12 with the encryption/decryption procedure, a crypto engine 16 will encrypt the plain text 14 to a cipher text 15 according to a cipher key 13, and the cipher text 15 will be transmitted to the receiver 12. After receiving the cipher text 15 from the sender 11, the crypto engine 16 of the receiver 12 will decrypt the cipher text 15 to the plain text 14 according to the cipher key 13. This kind of algorithm in which the sender and the receiver have same cipher key is called a symmetric cryptographic algorithm. If the cipher keys of the sender and the receiver are different, that is called an asymmetric cryptographic algorithm. In the process of data transmission, the data is protected by the cipher text. Only the sender and the receiver having the correct cipher key can decrypt the cipher text, so the data can be protected.

In the conventional crypto engine, different types of buffer memory are utilized to store the cipher key, the input data and the result. Please refer to FIG. 2, which is a functional diagram of a conventional crypto engine 20. The crypto engine 20 firstly stores the input data in a buffer memory 21 and stores the cipher key in a buffer memory 22, and then the input data and the cipher key are inputted into a processor 24 to process the encryption/decryption operation. After the processor 24 finishes operation, the result will be stored into a buffer memory 23. The conventional crypto engine 20 utilizes three kinds of buffer memory for each encryption or decryption operation. This practice not only wastes hardware resources, but also enlarges the chip size.

### SUMMARY OF INVENTION

It is therefore a primary objective of the claimed invention to provide a method for managing a buffer memory with multiple functions to solve the above-mentioned problem of using too many buffer memories in the crypto engine.

According to the claimed invention, a method for managing a buffer memory is disclosed. The buffer memory is applied to a crypto engine, and the crypto engine encrypts or decrypts an input data to produce a result through an encryption algorithm or a decryption algorithm. The claimed method includes: defining an input/output (IO) writing address, a program reading address, a program writing address, and an IO reading address in the buffer memory. Input data is written into the IO writing address, and then the crypto engine reads the input data beginning at the program reading address to perform the encryption or decryption processes. After the encryption or decryption processes, the result of the processes is written into the program writing address, and then the result is read beginning at the IO reading address. When the IO writing address is different from the program reading address, the crypto engine is controlled to read the input data. When the program writing address is different from the IO reading address, the buffer memory is controlled to output the result.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional diagram of an encryption/decryption procedure according to prior art.

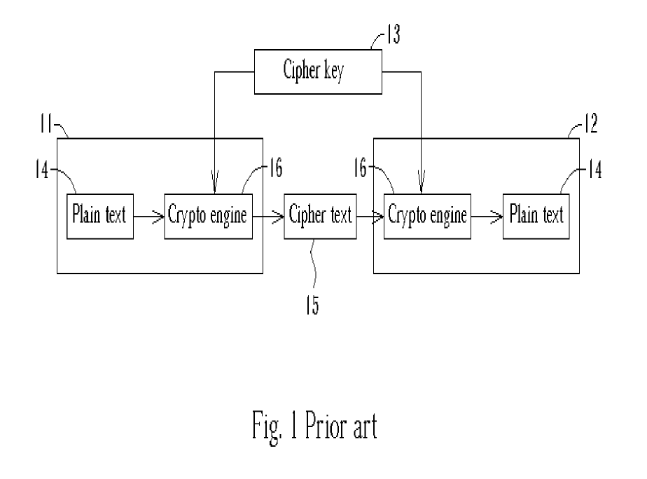

FIG. 2 is a functional diagram of a crypto engine according to prior art.

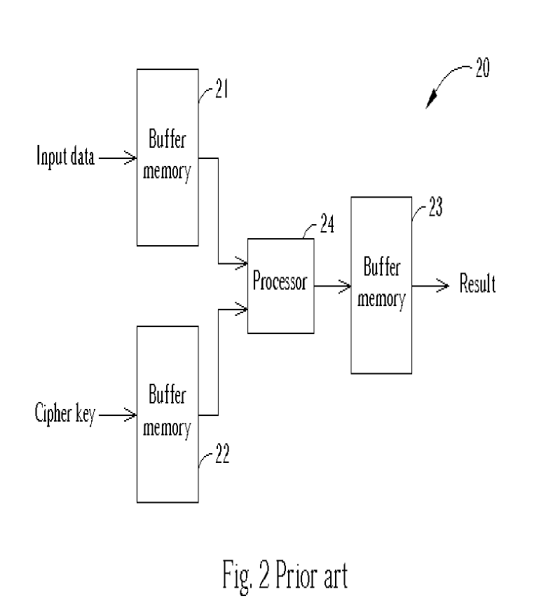

FIG. 3 is a functional diagram of a crypto engine according to present invention.

FIG. 4 is a schematic diagram of a buffer memory in FIG. 3.

### DETAILED DESCRIPTION

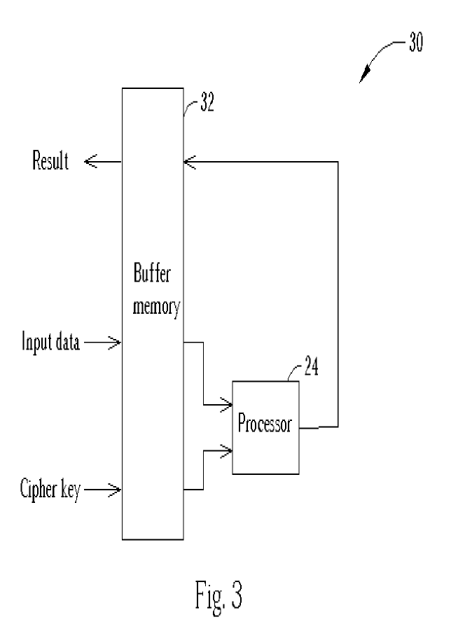

Please refer to FIG. 3, which is a functional diagram of a crypto engine 30 according to present invention. The crypto engine 30 has a processor 24 for performing the cryptography, and a buffer memory 32 for storing data. Similar to the conventional cryptographic procedure, the crypto engine 30 utilizes a cipher key to encrypt the plain text or decrypt the cipher text. In FIG. 3, the plain text needing encrypting or the cipher text needing decrypting is marked as an input data, and the cipher text after encrypting or the plain text after decrypting is marked as a result. The input data is firstly stored into the buffer memory 32, and then transferred to the result by the processor 24. After storing the input data into the buffer memory 32, the processor 24 will read the input data out from the buffer memory 32 to perform the crypto algorithm, and the buffer memory 32 is utilized to store the cipher key and some temporary data while processing. When performing the crypto algorithm, the processor is operated with a unit of a predetermined data quantity, such as 128 bits. After the professor 24 finishes processing each data unit, the result will be stored into the buffer memory 32. During the input/output and encrypting/decrypting procedure, the same buffer memory 32 is used to store data, and the data confusion is avoided by managing the reading/writing addresses of the buffer memory 32. The number of the buffer memory can be reduced. In addition, the crypto engine 30 can also respectively manage more than one buffer memory with the claimed method, that is to say, one crypto engine can be operated with more than one buffer memory managed by the claimed method.

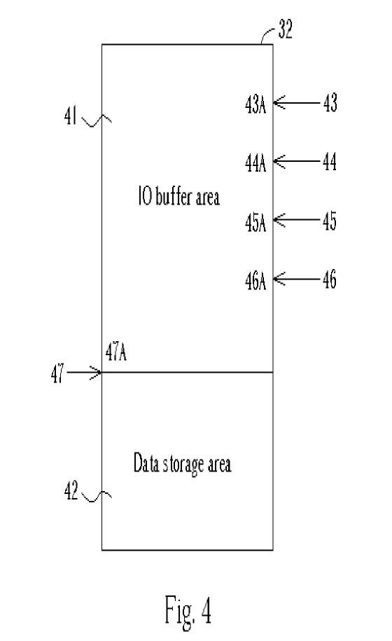

Please refer to FIG. 4, which is a schematic diagram of the buffer memory 32 in FIG. 3. The buffer memory 32 is divided into an input/output (IO) buffer area 41 and a data storage area 42 in accordance with the data length, and a buffer end pointer 47 is used for defining a buffer end address 47A to appoint the boundary of the IO buffer area 41 and the data storage area 42. In addition, the IO buffer area 41 is used for storing the input data and the result, and the data storage area 42 is used for storing the cipher key and so on.

The crypto engine 30 uses a program reading pointer 45 and an IO writing pointer 46 to record the memory address for accessing the input data in the buffer memory 32 later. The program reading pointer 45 defines a program reading address 45A, and the IO writing pointer 46 defines an IO writing address 46A. The input data is stored in the buffer memory 32 beginning at the IO writing address 46A, and the crypto engine 30 reads out the input data from the buffer memory 32 beginning at the program reading address 45A to perform the encryption/decryption operation. As the input data is continually written into the buffer memory 32, the IO writing pointer 46 is triggered, and the IO writing address 46A increases progressively corresponding to the quantity of the stored data. When the IO writing address 46A equals the buffer end address 47A, the IO writing address 46A will be set to zero. Similarly, as the input data is continually read out, the program reading pointer 45 is triggered, and the program reading address 45A increases progressively corresponding to the quantity of the read data. When the program reading address 45A equals the buffer end address 47A, the program reading address 45A will be set to zero. Hence, when the IO writing address 46A is bigger than the program reading address 45A, the input data is stored between the program reading address 45A and the IO writing address 46A. When the IO writing address 46A is smaller than the program reading address 45A, the input data is stored between the starting address of the buffer memory 32 and the IO writing address 46A, and between the program reading address 45A and the buffer end address 47A. In addition, if the program reading address 45A is different from the IO writing address 46A, that means having some input data stored in the IO buffer area 41, and if the program reading address 45A equals the IO writing address 46A, that means the input data stored in the IO buffer area 41 is all read out by the processor 24. The crypto engine 30 can read/write the input data in the buffer memory 32 according to the program reading address 45A and the IO writing address 46A.

Because the crypto engine 30 is operated with a unit of a predetermined data quantity (such as 128 bits), before the data quantity in the IO buffer area 41 reaches the predetermined data quantity, the crypto engine 30 will suspend reading the input data from the program reading address 45A until the data quantity of the accumulated input data in the IO buffer area 41 reaches the predetermined data quantity. When the input data accumulated in the IO buffer area 41 reaches the predetermined data quantity, a flag will be triggered for the processor 24 reading the input data from the buffer memory 32 to perform the encryption/decryption operation.

The processor 24 performs the encryption/decryption operation according to the cipher key stored in the data storage area 42. Besides the cipher key, there is other temporary data stored in the data storage area 42, such as the round key. After the processor 24 finishes the operation, the result will be stored in the IO buffer area 41, and an IO reading pointer 43 and a program writing pointer 44 are used for recording the related memory addresses. The IO reading pointer 43 defines an IO reading address 43A, and the program writing pointer 44 defines a program writing address 44A. The result is stored in the buffer memory 32 beginning at the program writing address 44A, and then the result stored in the buffer memory 32 is read out beginning at the IO reading address 43A. As the result is continually written into the buffer memory 32, the program writing pointer 44 is triggered, and the program writing address 44A increases progressively corresponding to the quantity of the stored result. When the program writing address 44A equals the buffer end address 47A, the program writing address 44A will be set to zero. Similarly, as the result is continually read out, the IO reading pointer 43 is triggered, and the IO reading address 43A increases progressively corresponding to the quantity of the read result. When the IO reading address 43A equals the buffer end address 47A, the IO reading address 43A will be set to zero. Hence, when the program writing address 44A is bigger than the IO reading address 43A, the result is stored between the IO reading address 43A and the program writing address 44A. When the program writing address 44A is smaller than the IO reading address 43A, the result is stored between the starting address of the buffer memory 32 and the program writing address 44A, and between the IO reading address 43A and the buffer end address 47A. In addition, if the IO reading address 43A is different from the program writing address 44A, that means having some result stored in the IO buffer area 41, and if the IO reading address 43A equals the program writing address 44A, that means the result stored in the IO buffer area 41 is all outputted. The crypto engine 30 can read/write the result in the buffer memory 32 according to the IO reading address 43A and the program writing address 44A.

When the crypto engine 30 processes the encryption/decryption operation, the IO buffer area 41 is used for storing the input data and the result, and the data storage area 42 is used for storing the cipher key and so on. Since the buffer end address 47A distinctly separates the IO buffer area 41 and the data storage area 42, every data has its storage address without confusion. In addition, in this embodiment, the buffer end pointer 47 is used for defining the buffer end address 47A in the buffer memory 32 to divide the IO buffer area 41 and the data storage area 42. The input data is stored between the program reading address 45A and the IO writing address 46A, and the result is stored between the IO reading address 43A and the program writing address 44A. By managing the accessing address of the buffer memory, the buffer memory 32 can have multiple functions and can reduce the quantity of buffer memory in the crypto engine.

In contrast to the prior art, the present invention having the feature of using the multi-functional buffer memory can reduce the quantity of buffer memory used in the crypto engine and can thereby lower the cost and narrow the chip size.

Those skilled in the art will readily observe that numerous modifications and alterations of the device may be made while retaining the teachings of the invention. Accordingly, the above disclosure should be construed as limited only by the metes and bounds of the appended claims.

1. A method for managing a buffer memory, the buffer memory is applied to a crypto engine, the crypto engine encrypting or decrypting an input data to produce a result through an encryption algorithm or a decryption algorithm, the method for managing the buffer memory comprising:
defining an input/output (IO) writing address in the buffer memory, the input data being written into the buffer memory beginning at the IO writing address;
defining a program reading address in the buffer memory, the crypto engine reading out the input data beginning at the program reading address to process the encryption algorithm or the decryption algorithm;
defining a program writing address in the buffer memory, the result of the crypto engine being written into the buffer memory beginning at the program writing address;
defining an IO reading address in the buffer memory, the crypto engine reading out the result beginning at the IO reading address and outputting the result;
when the IO writing address is different from the program reading address, controlling the crypto engine to read the input data beginning at the program reading address; and
when the program writing address is different from the IO reading address, controlling the buffer memory to output the result beginning at the IO reading address.

2. The method of claim 1 further comprising:
while the input data is written into the buffer memory, changing the IO writing address in accordance with quantity of the input data;
while the crypto engine reads the input data, changing the program reading address in accordance with quantity of the input data;
while the result is written into the buffer memory, changing the program writing address in accordance with quantity of the result; and
while the buffer memory outputs the result, changing the IO reading address in accordance with quantity of the result.

3. The method of claim 1 further comprising:
defining a buffer end address in the buffer memory according to a data length request of the crypto engine processing the encryption algorithm or the decryption algorithm, and dividing the buffer memory into an IO buffer area and a data storage area according to the buffer end address;
storing the input data and the result in the IO buffer area; and
storing a cipher key in the data storage area, wherein the crypto engine utilizes the cipher key to process the encryption algorithm or the decryption algorithm.

4. The method of claim 1 further comprising:
while quantity of the input data stored between the IO writing address and the program reading address is smaller than a predetermined quantity, the crypto engine being controlled to suspend reading the input data beginning at the program reading address until quantity of the input data stored between the IO writing address and the program reading address is larger than or equal to the predetermined quantity.
